(19) United States
(12) Patent Application Publication
(10) Pub. No.: US 2008/0163624 A1
(43) Pub. Date: Jul. 10, 2008

(54) Pipe Line for a Turbocharger System for an Internal Combustion Engine

(75) Inventors: Jonas Augustinson, Vellinge (SE); Sebastian Krausche, Hollviken (SE); Magnus Ising, Lund (SE); Per Andersson, Malmo (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 11/573,646

(22) PCT Filed: Sep. 21, 2004
(86) PCT No.: PCT/SE04/01348

§ 371 Date: Feb. 13, 2007

(51) Int. Cl. F02G 3/00

(52) U.S. Cl. 60/624; 138/177

(57) ABSTRACT

A pipe line for a turbocharger system for an internal combustion engine has at least one exhaust line for the evacuation of exhaust gases from the combustion chamber of the engine to the turbocharger system and at least one inlet line for the supply of air to the combustion chamber. The turbocharger system includes at least one turbine, which cooperates with at least one compressor to extract energy from the exhaust flow of the engine and pressurize the inlet air of the engine. To allow a compact installation with low pressure losses, the inlet line connects with a curved line section of an outlet from the compressor, at least a part-section of the curved line section having a non-circular cross section. A diffuser is placed less than five pipe diameters downstream of the curved line section.

### BACKGROUND AND SUMMARY

The present invention relates to a pipe line for a turbocharger system for an internal combustion engine having at least one exhaust line for the evacuation of exhaust gases from the combustion chamber of the engine to the turbocharger system and at least one inlet line for the supply of air to said combustion chamber, which turbocharger system comprises at least one turbine, which cooperates with at least one compressor to extract energy from the exhaust flow of the engine and pressurize the inlet air of the engine.

The state of the art as regards turbocharger systems for the supercharging of diesel-type internal combustion engines, especially for heavy-duty vehicles, usually comprises a single-stage compressor driven by a single-stage turbine, both of the radial type. Turbocharger systems with two-stage supercharging are also found, sometimes also including intermediate cooling, but such installations usually take up a lot of space. Technical solutions of this kind are therefore difficult to apply to motor vehicles in which the space is severely limited. Environmental requirements usually mean that installation space in the engine compartment is additionally encumbered with equipment for exhaust gas aftertreatment, for example an EGR system for the recirculation of cooled exhaust gases from the exhaust side to the inlet side. Demands for engines to be more efficient can also generate the need to increase the cooling system capacity, which steals more space around the engine. It is therefore a great challenge to configure the pipe lines between the engine and the turbocharger system such that the pressure losses in the lines are minimized. If this problem is not adequately resolved, there is a risk that the benefit of using two-stage supercharging will be substantially offset by losses resulting from compromises in the installation.

It is desirable therefore to produce a pipe line with low pressure losses which facilitates the installation of a turbocharger system for an internal combustion engine.

A pipe line, which is according to the invention and which is configured for the purpose, for a turbocharger system for an internal combustion engine having at least one exhaust line for the evacuation of exhaust gases from the combustion chamber of the engine to the turbocharger system and at least one inlet line for the supply of air to said combustion chamber comprises at least one turbine, which cooperates with at least one compressor to extract energy from the exhaust flow of the engine and pressurize the inlet air of the engine, and is characterized in that the inlet line connects with a curved line section to an outlet from the compressor, at least a part-section of the curved line section having a non-circular cross section, and in that a diffuser is placed less than five pipe diameters downstream of the curved line section. As a result of this configuration of the pipe line, it can be run in a space-saving, compact manner from the compressor with a tight bend up to a charge-air cooler placed at the front end of a vehicle, without any significant increase in the fall in pressure in the pipe line.

### BRIEF DESCRIPTION OF THE FIGURES

The invention will be described in greater detail below with reference to illustrative embodiments shown in the appended drawings, in which:

FIG. 1 shows in diagrammatic representation an internal combustion engine having a two-stage turbocharger system,

FIG. 2 shows the pipe line according to the invention in perspective view, and

FIG. 3 shows the pipe line in FIG. 2 in plane view.

### DETAILED DESCRIPTION

The invention is described as used in a two-stage supercharging system for, primarily, diesel engines having a cubic capacity of between about 6 and about 20 liters, for use especially on heavy-duty vehicles such as trucks, buses and construction machinery. A characteristic of the supercharging system is that it gives a considerably more effective supercharge compared with current systems. The supercharging is realized in two stages with two series-connected compressors of the radial type, with intermediate cooling. The first compressor stage, referred to as the low-pressure compressor, is driven by a low-pressure turbine of the axial type. The second compressor stage, the high-pressure compressor, is driven by a high-pressure turbine of the radial type.

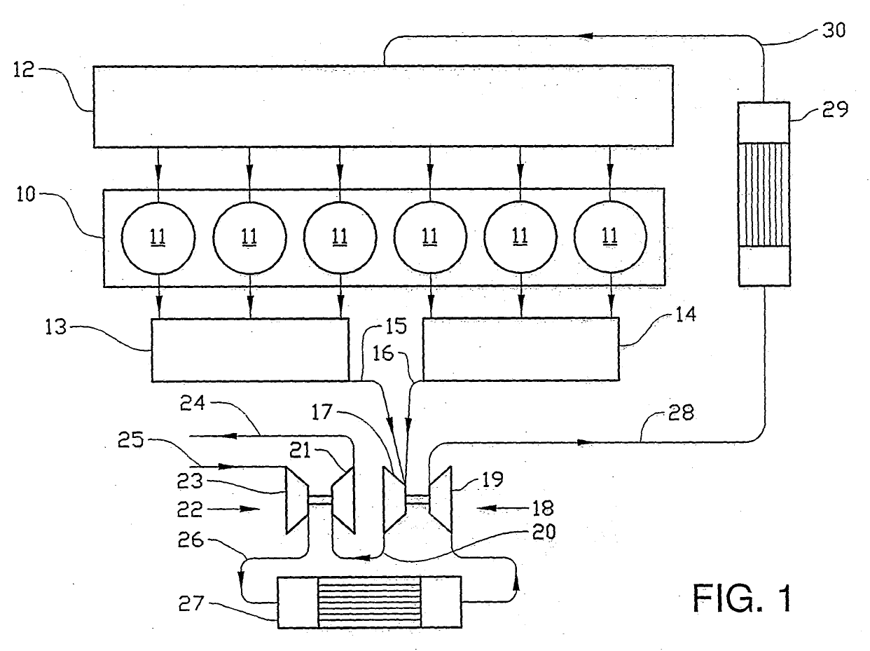

FIG. 1 shows an engine block 10 comprising six engine cylinders 11, which communicate conventionally with an induction manifold 12 and two separate exhaust manifolds 13, 14. Each of these two exhaust manifolds receives exhaust gases from three of the engine cylinders. The exhaust gases are conducted via separate pipe lines 15, 16 up to a turbine 17 in a high-pressure turbo unit 18, which comprises a compressor 19 mounted on a common shaft with the turbine 17.

The exhaust gases are conducted onward through a pipe line 20 to a turbine 21 in a low-pressure turbo unit 22, which comprises a compressor 23 mounted on a common shaft with the turbine 21. The exhaust gases are finally conducted onward through a pipe line 24 to the exhaust system of the engine, which can comprise units for the aftertreatment of exhaust gases.

Filtered inlet air is admitted to the engine through the pipe line 25 and is conducted to the compressor 23 of the low-pressure turbo unit 22. A pipe line 26 conducts the inlet air onward via a first charge-air cooler 27 to the compressor 19 of the high-pressure turbo unit 18. Following this two-stage supercharging with intermediate cooling, the inlet air is conducted onward through the pipe line 28 to a second charge-air cooler 29, after which the inlet air reaches the induction manifold 12 via the pipe line 30.

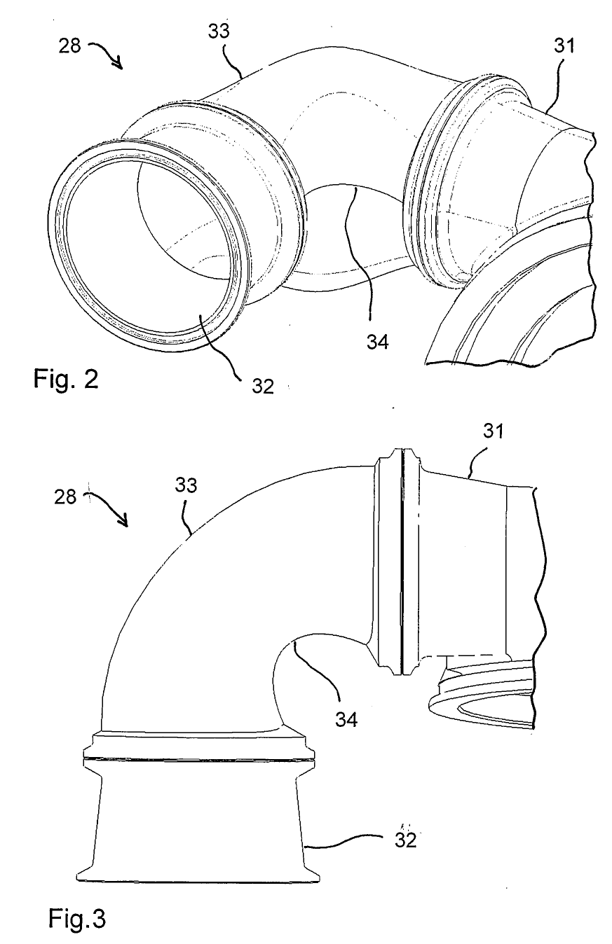

The pipe line 28 is shown on larger scale in FIG. 2, which, in its right-hand part, shows the conical diffuser outlet 31 from the compressor 19. In order to limit the fall in pressure in the pipe line downstream of the compressor, a diffuser 32 has been placed downstream of a curved pipe section 33. The diffuser 32 expediently widens conically in the direction of flow and is otherwise standardly configured.

A space-saving installation of the pipe line 28 is facilitated by the fact that the pipe section 33, which in this illustrative embodiment is curved at an angle of about 90 degrees, has a small radius of curvature. Normally, the performance of the diffuser placed downstream of the pipe section is considerably affected, with regard to static pressure increase and pressure fall, by the quality of the speed profile in terms of the uniformity of the flow passing through the curved pipe section. According to the invention, this flow quality has been improved by the fact that the cross section of the curved pipe section is non-circular upstream of the diffuser. The pipe section is here expediently compressed in such a way that the flow acquires a more uniform curve radius, at the same time as the cross-sectional area is approximately constant. The compression of the curved bend section should here be realized in such a way that the length of the shortest flow line, i.e. the shortest path which fluid particles can follow, is increased by comparison with a corresponding curved line section of circular cross section. Expediently, the curved pipe section 33 is configured in conformity with a so-called NACA bend, see, for example, NACA TN 2736, June 1952, which document shows two-dimensional flow through a bend.

The diffuser 33 is expediently placed within a distance of maximally five pipe diameters downstream of the curved line section. In practice, it can however be advantageous to place the diffuser within a distance of maximally two pipe diameters, or as close to the curved line section as is expedient, in order to reduce the length of the pipe line.

The invention should not be deemed to be limited to the illustrative embodiments described above, but rather a number of further variants and modifications are conceivable within the scope of the subsequent patent claims. For example, the pipe line 26 can be configured with a corresponding curved pipe section with following diffuser. In addition, the pipe line 28 can be configured with more than one diffuser and more than one curved pipe section 33, which pipe sections can have freely chosen curve angles. In addition, the pipe section 33 can be preceded by a conical diffuser.

1. A pipe line for a turbocharger system for an internal combustion engine having at least one exhaust line for evacuation of exhaust gases from a combustion chamber of the engine to the turbocharger system and at least one inlet line for supplying air to the combustion chamber, which turbocharger system comprises at least one turbine, which cooperates with at least one compressor to extract energy from exhaust flow of the engine and pressurize the inlet air of the engine, wherein the inlet line connects with a curved line section of an outlet from the compressor, at least a part-section of the curved line section having a non-circular cross section, and a diffuser is placed less than five pipe diameters downstream of the curved line section.

2. The pipe line as claimed in claim 1, wherein the curved line section is compressed in such a way that a length of the shortest flow line is increased by comparison with a corresponding curved line section of circular cross section.

3. The pipe line as claimed in claim 2, wherein the curved line section is compressed in such a way that a distance to a center of gravity of the cross-sectional area, from a center of curvature for a corresponding curved line section of circular cross section increases, and then decreases.

4. The pipe line as claimed ib claim 1, wherein the diffuser is placed less than two pipe diameters downstream of the curved line section.

5. The pipe line as claimed in claim 1, wherein the diffuser is placed less than one pipe diameter downstream of the curved line section.

6. The pipe line as claimed in claim 1, wherein the curved line section is preceded by a diffuser.

7. The pipe line as claimed in claim 1, wherein the turbocharger is intended for a turbo system with two-stage supercharging in which compressors and turbines are arranged in series.

8. The pipe line as claimed in claim 1, wherein the internal combustion engine is a diesel engine.

9. The pipe line as claimed in claim 8, wherein the internal combustion engine is mounted in a heavy-duty vehicle.

10. The pipe line as claimed in claim 2, wherein the diffuser is placed less than two pipe diameters downstream of the curved line section.

11. The pipe line as claimed in claim 2, wherein the diffuser is placed less than one pipe diameter downstream of the curved line section.

12. The pipe line as claimed in claim 2, wherein the curved line section is preceded by a diffuser.

13. The pipe line as claimed in claim 2, wherein the turbocharger is intended for a turbo system with two-stage supercharging in which compressors and turbines are arranged in series.

14. The pipe line as claimed in claim 2, wherein the internal combustion engine is a diesel engine.
